(19) United States
(12) Patent Application Publication
(10) Pub. No.: US 2025/0144865 A1
(43) Pub. Date: May 8, 2025

(54) MULTI-LAYER PEX PIPE AND METHODS FOR FORMING THE SAME

(71) Applicant: RELIANCE WORLDWIDE CORPORATION, Atlanta, GA (US)

(72) Inventor: Michael Shane Leo CASAVANT, Atlanta, GA (US)

(21) Appl. No.: 18/935,331

(22) Filed: Nov. 1, 2024

Related U.S. Application Data
(60) Provisional application No. 63/595,372, filed on Nov. 2, 2023.

(51) Int. Cl. B29C 48/09; B29C 48/00; B29C 48/21; B29C 48/88; B29C 48/91; B29K 23/00; B29L 23/00; B32B 1/08; B32B 7/02; B32B 27/08; B32B 27/22; B32B 27/32; F16L 11/04

(52) U.S. Cl. CPC B29C 48/09; B29C 48/022; B29C 48/21; B29C 48/9105; B29C 48/919; B32B 1/08; B32B 7/02; B32B 27/08; B32B 27/22; B32B 27/32; F16L 11/04; B29K 2023/065; B29K 2023/0691; B29K 2995/002; B29K 2995/0058; B29K 2995/0097; B29L 2023/22; B32B 2250/03; B32B 2250/242; B32B 2307/4026; B32B 2307/714; B32B 2307/7376; B32B 2597/00; F16L 2011/047

(57) ABSTRACT

The present disclosure relates to a multi-layered PEX pipe where the core layer or center layer is a cross-linked polyethylene PEX which is sandwiched between two stabilized Polyethylene layers that are not cross-linked. The core PEX-a layer is a major proportion of the pipe's cross sectional area and thus is the primary stress-bearing layer of the pipe product. The present disclosure also relates to a method of extruding all layers simultaneously to make a composite PEX pipe.

### PRIORITY CLAIM

This Application claims priority to U.S. Provisional Patent Application No. 63/595,372, filed Nov. 2, 2023.

### INCORPORATION BY REFERENCE

The disclosure and figures of U.S. Provisional Patent Application No. 63/595,372, filed Nov. 2, 2023, are incorporated by reference herein as if set forth in their entirety.

### TECHNICAL FIELD

The present disclosure relates generally to PEX-a pipe and methods of making plastic pipes, specifically to PEX-a process in which there are multiple layers.

### BACKGROUND

Extruded plastic pipe or tubing is well known and can be used for a variety of applications. Examples of materials used for manufacturing plastic piping can include polyolefins such as polyethylene (PE) (e.g., PE-raised temperature, or PE-RT), polypropylene (PP), polybutylenes (PB), and any copolymers thereof; polyolefin copolymers such as poly (ethylene-co-maleic anhydride); poly (vinyl chloride) (PVC); and chlorinated PVC, i.e., CPVC; etc.

In certain examples, a cross-linked polymer, such as cross-linked polyethylene (PEX), may be used for making plastic pipes. PEX-a, PEX-b, and PEX-c are known varieties of PEX for making plastic pipe. When manufacturing PEX-a, crosslinking is induced by peroxide under heat and pressure. The PEX-a composition is crosslinked through carbon-carbon bonds to form a crosslinked polymer network. The PEX-a crosslinking process occurs in a melted stage, as opposed to the primary crosslinking processes for PEX-b and PEX-c.

There is a need for a more improved process for manufacturing a PEX-a pipe or tube that is faster and simpler and results in less waste.

### SUMMARY

The present disclosure relates to a method that provides cheaper and more efficient, cost-efficient, and environmentally friendly ways of producing PEX-a pipe or tube. It is furthermore an object of the present disclosure to provide PEX-a pipe with improved functional properties, preferably to contain stabilizer chemicals for pipe longevity and protection from oxidation. The pipes can be used in both cold and hot water applications. PEX-a is produced by a peroxide (Engel) method. This method performs “hot” cross-linking, above the crystal melting point. The “Engel” or peroxide method employs a special extruder with an intermeshing screw action where peroxide is added to the base resin and through a combination of pressure and high temperature the cross-linking takes place as the tubing is produced.

In the PEX-a process, the primary reaction is the formation of free radicals upon decomposition of the peroxide. The free radical abstracts hydrogens from the PE polymer chains which give new carbon radicals that combine with carbon radicals on neighboring PE chains to form stable carbon-carbon bonds, i.e., crosslinks. The crosslinking is homogeneous and uniform and gives degrees of crosslinking between 70%-89%.

One aspect of the present disclosure relates to a multi-layered PEX pipe where the core layer or center layer is a cross-linked polyethylene PEX which is sandwiched between two stabilized Polyethylene layers that are not cross-linked. The core PEX-a layer is a major proportion of the pipe's cross sectional area and thus is the primary stress-bearing layer of the pipe product. The core PEX-a layer may contain stabilizer chemicals for pipe longevity. The two stabilized polyethylene layers are thin, skin-like layers that sandwich the PEX-a layer. The two stabilized polyethylene layers make up a minor proportion of the pipe's cross-sectional area. The two stabilized polyethylene layers may include an inner layer and an outer layer. The inner layer may function as a barrier to protect an inner surface of the pipe that is exposed to water during use. The inner layer may contain stabilizer chemicals for pipe longevity to protect from oxidation by hot, chlorinated, circulating water. The outer layer may function to provide color to the pipe product. As such, the outer layer may include a color additive. The outer layer may also provide increased UV resistance and an improved surface finish of the pipe product.

Another aspect of the present disclosure relates to a method of extruding all layers simultaneously to make PEX pipe. As such, intermediate adhesive layers are not needed.

These and other features and advantages will be apparent from a reading of the following detailed description and a review of the associated drawings. A variety of additional aspects will be set forth in the description that follows. The aspects can relate to individual features and to combinations of features. It is to be understood that both the foregoing general description and the following detailed description are exemplary and explanatory only and are not restrictive of the broad concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates perspective schematic view of a multilayer PEX pipe in accordance with principles of the present disclosure.

FIG. 2 illustrates a cross-sectional view of the multilayer PEX pipe of FIG. 1.

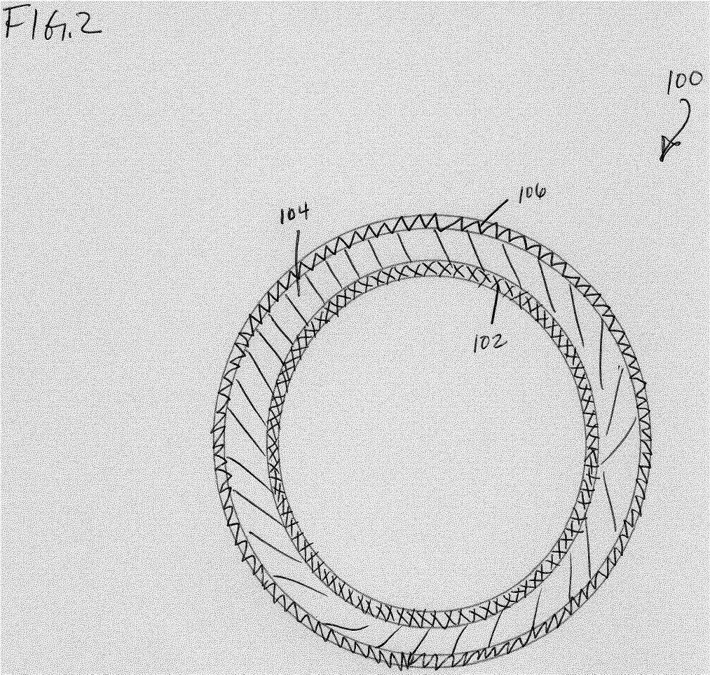

### DETAILED DESCRIPTION

The present disclosure relates to systems and methods of making a uniform elongated tubular element, such as but not limited to, a multi-layered pipe. The systems and methods described herein are generally in reference to making a PEX-a pipe, although various aspects of the process may be used in making PEX-b and PEX-c piping or tubing.

The advantageous features of a PEX-a material include the flexibility that the PEX-a material provides. PEX-a is expandable, which makes it preferred for use with mechanical fittings, but other types of PEX can be used with mechanical fittings in accordance with the principles of the disclosure. The PEX-a material has a smaller bend radius compared to the PEX-b or PEX-c material. PEX-a material also has an elastic memory so it can be expanded to use expansion fittings. That is, a PEX-a pipe can be expanded and then shrink back around the fitting to provide a tight seal. PEX-a will tend to return to its original shape in which it was extruded. If a kink is created in a PEX-a pipe, a heat gun can be used to heat the pipe or tube to return the pipe/tube to its original shape. Secondary processes further are not needed to crosslink the PEX-a after extrusion.

In an embodiment, the present disclosure is directed to a new process for manufacturing PEX-a pipe. In connection with the present disclosure, it has surprisingly been found that coextruding three layers of material to make a pipe or tube may result in an improved product with improved functional properties. The process includes coextruding simultaneously the three layers of pipe or tube. The three-layer co-extruded tubing is characterized in that an elongated tubing is divided into three layers, from outside within be respectively a color layer, a PEX layer, and a protective layer. The thickness ratio of the color layer, the main PEX layer and the protective layer will change depending on pipe size. For example, a smaller pipe that is about ½ inches, may have a ratio of 1:25:1, although alternatives are possible. A larger pipe, for example about 2 inches, may have a ratio of 1:88:1, although alternatives are possible. The co-extrusion process eliminates the need for intermediate adhesive layers and post heat treating ovens. The benefits can include improved barrier potential to chemical migration and pipe longevity.

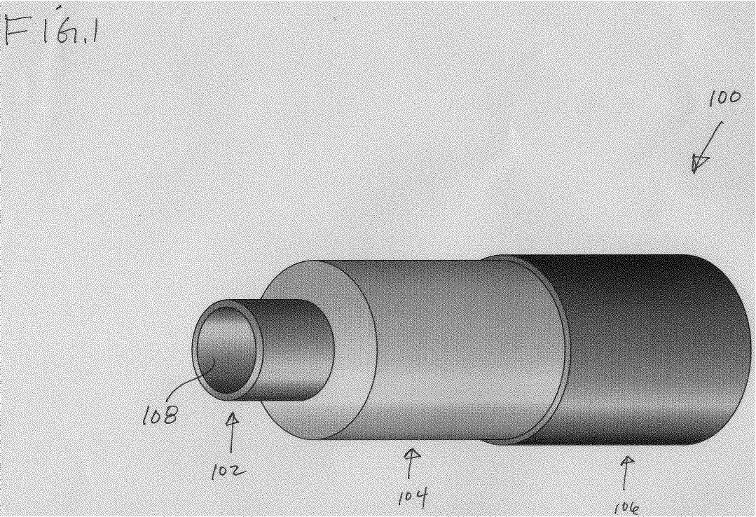

FIG. 1 is a schematic view of a multilayer PEX pipe 100. In the example depicted, the example is a PEX-a pipe, but aspects of the disclosure may also be applicable to PEX-b and PEX-c. The multilayer PEX pipe 100 depicted includes a first layer 102 (e.g., inner layer), a second layer 104 (e.g., middle layer), and a third layer 106 (e.g., outer layer). The composition of the first layer 102, the second layer 104, and the third layer 106 may each be different. As illustrated, the second layer 104 has a major proportion of the pipe's cross-sectional area and is the main PEX-a layer. The first and third layers 102, 106 of the multilayer PEX pipe 100 have a minor proportion of the pipe's cross-sectional area and may be thin layers, although alternatives are possible. An outer diameter (O.D.) of the multilayer PEX pipe 100 may be within +/−0.3 mm, within +/−0.2 mm, or within +/−0.1 mm when measured at a plurality of intervals along the multilayer PEX pipe 100, although alternatives are possible. Each of the layers in the multilayer PEX pipe 100 will now be described.

The first layer 102 may include stabilizer chemicals that impart pipe longevity and protection from oxidation by hot, chlorinated, circulating water. The first layer 102 forms an inner surface 108 of the multilayer PEX pipe 100 which is the portion that directly comes into contact with water during normal use. The first layer 102 also functions as a physical barrier between the second layer 104 and the inner surface 108 of the multilayer PEX pipe 100.

The first layer 102 of the multilayer PEX pipe 100 may be comprised of a high molecular weight, high density polyethylene, although alternatives are possible. The high density polyethylene is compatible with the second layer 104 such that it forms an integral bond therewith. That is, the high density polyethylene may form a chemical crosslinking bond with the second layer 104 and/or physical bond at the interface of the second layer 104. As such, the first and second layers 102, 104 do not delaminate under reasonable test conditions.

In certain examples, the first layer 102 of the multilayer PEX pipe 100 may experience thermal and oxidative stresses both during and after processing. As such, the first layer 102 may include stabilizer chemicals that provides good resistance to such thermal and oxidative stresses. Depending upon the polymer used in the first layer 102, the first layer 102 could also act as a stress-bearing layer, adding strength and longevity to the multilayer PEX pipe 100. The first layer 102 may be mixed with other materials to impart desired properties such as, but not limited to, resistance to chlorinated water. The first layer 102 may act as a barrier and prevent chemicals from permeating through to the second layer 104 or permeating out from the second layer 104. For example, the first layer 102 may include a crystalline or semi-crystalline structure that impedes the diffusion of chemicals in the second layer 104. As such, the first layer 102 may minimize the migration of precursor chemicals from the second layer 104 to the inner surface 108. The multilayer PEX pipe 100 may include chlorine resistant and/or ultraviolet light resistant properties. The useful and advantageous composition can result in a lesser amount of chloroform being generated under specific NSF certification or test conditions. Such structure can help eliminate the formation of methyl ketones at the inner surface 108 of the multilayer PEX pipe 100. The multilayer PEX pipe 100 is designed to meet or exceed chlorine resistance standards according to ASTM F876.

In certain examples, the first layer 102 of the multilayer PEX pipe 100 may include any combination of one or more of the following: no additives at all, a UV stabilization package, an oxidation stabilization package (specifically for aqueous chlorine, chloramine, hypochlorite, chlorine dioxide, permanganate, or other oxidizing agents used for the purpose of potable water treatment, or copper ions, metal ions, mineral ions, or other chemicals that may be present in the water from a natural or man-made source), a material that acts as a semipermeable barrier to chemicals (specifically for peroxides, ketones, methyl ketones, alcohols, and diols), or a material that acts as a barrier to damage by erosion. It will be appreciated that the first layer 102 may include a stabilized resin. In certain examples, the first layer 102 may contain colorants or thermal stabilizers or other functional chemicals. Selected advantages can be achieved while not using all of the features depicted and discussed.

The second layer 104 of the multilayer PEX pipe 100 is primarily designed to be the primary stress-bearing layer of the multilayer PEX pipe 100. The second layer 104 may include PEX-a, PEX-b, or PEX-c material, which are produced to pass applicable industry certification requirements. In certain examples, the second layer 104 may contain stabilizer chemicals for pipe longevity.

In certain examples, the second layer 104 of the multilayer PEX pipe 100 may include a solid or liquid color to impart a full-wall color to the multilayer PEX pipe 100. As such, obtaining a color may be achieved by the second layer 104 instead of relying solely on the third layer 106 to carry the colorant. In certain examples, the second layer 104 may be designed similar to a PEX-b pipe where the PEX-b material has a colorant throughout the entire wall of the pipe. It will be appreciated that any colorant material to the second layer 104 will result in a product that meets industry certification guidelines.

The main function of the third layer 106 is to impart color to the multilayer PEX pipe 100. It will be appreciated that the third layer 106 may also impart increased ultraviolent resistance and improved surface finish to the multilayer PEX pipe 100. Similar to the first layer 102, the third layer 106 may comprise a high molecular weight, high density polyethylene, although alternatives are possible. The high density polyethylene is compatible with the PEX-a, PEX-b, or PEX-c material of the second layer 104. As such, when the multilayer PEX pipe 100 is co-extruded, the third layer 106 will form an integral bond with the PEX-a, PEX-b, or PEX-c material of the second layer 104 due to chemical crosslinking and/or physical mixing at the layer interfaces. The level of cross-linking of the second layer 104 may be within a range of 70% to 89%, 70% to 80%, or at least 70% when tested according to ASTM F876. Alternatively, in applications where a PEX-b pipe or a PEX-c pipe is formed, the level of cross-linking may be within a range of 65% to 89%.

The third layer 106 of the multilayer PEX pipe 100 may also include a stabilizer package to impart sufficient thermal stability that allows the multilayer PEX pipe 100 to withstand up to 30 seconds in IR ovens without significant degradation. Furthermore, when in a molten state, the third layer 106 may have non-stick properties such that any contact with rollers, wheels, or calibrators during processing does not result in material buildup, pick-off or chattering.

Optionally, the third layer 106 of the multilayer PEX pipe 100 may include other materials. The “other materials” may include color resin, ultraviolet stabilizers, or other functional materials that add and/or improve the physical properties of the multilayer PEX pipe 100. The physical properties of the multilayer PEX pipe 100 may include a robust, smooth outer surface that is aesthetically and technically acceptable in color, gloss, slipperiness, or functionality with fitting systems. To produce a multi-layered PEX pipe having a satisfactory degree of adherence between layers, it is necessary to observe certain process limitations during the extrusion procedure. For example, extrusion temperatures for the multilayers are important. Furthermore, die temperature also is an important process variable. This parameter particularly affects the surface characteristics, e.g., gloss, surface smoothness, etc., of the co-extruded pipe. It is important to maintain the die temperature relatively constant during extrusion. Typical melt temperature values of the die may range between 320° F. and 430° F. Other processing variables may include the pressures at which the materials may be separately extruded before combination. The downstream pressure at the point where the three streams intersect is equal in all streams.

The third layer 106 of the multilayer PEX pipe 100 may also include any combination of one or more of the following: zero additives, a color master batch, an Ultraviolet stabilization package, an oxygen blocking material, any material that acts as a barrier to chemicals such as hydrocarbons, a material that acts as a barrier to physical damage. In certain examples, the third layer 106 of the multilayer PEX pipe 100 may comprise a stabilized resin.

Co-extrusion offers a process of preparing layered plastics that may be comprised of different materials. The co-extrusion process may use a three-layer co-extruder that includes a first extruder, a second extruder and a third extruder. The first extruder extrudes the first layer or inner layer, the second extruder extrudes the second layer or main core layer, and the third extruder extrudes the third layer or outer layer. The three layers can meet at a crosshead designed to bring two or more plastic materials from two or more extruders into contact with one another prior to their passage through an extrusion die. In certain examples, the temperature of the first and third extruders is about 320-400° F., and the temperature of the second extruder is about 350-440° F., although alternatives are possible. The first, second, and third extruders are converged into three layers at the extrusion die, and the first and third layers wrap the second layer and are integrally bonded with each other. That is, the first, second, and third layers 102, 104, 106 can come together using the crosshead. The first, second, and third layers 102, 104, 106 may be simultaneously co-extruded through a die head. The die head may be designed to form separate layers into a multi-layer composite such as a PEX-a pipe. The die head may include one, individual resin conduit for each resin layer to be formed. For example, a die head designed to form three-layers will include three individual resin conduits, and a die head for five-layers will include five individual resin conduits.

The co-extrusion process forms the first, second, and third layers 102, 104, 106 into the multilayer PEX pipe 100 such that the first and third layers 102, 106 may be thin, representing less than 25 volume percent of the total composite. In other examples, the first and third layers 102, 106 may be thin, representing less than 20 volume percent of the total composite. In other examples, the first and third layers 102, 106 may be thin, representing less than 15 volume percent of the total composite. In other examples, the first and third layers 102, 106 may be thin, representing less than 10 volume percent of the total composite. In other examples, the first and third layers 102, 106 may be thin, representing less than 5 volume percent of the total composite, although alternatives are possible.

In certain examples, the first layer 102 includes components calculated in parts by weight: 97 parts of polyethylene, and 38 parts of antioxidant agents, the second layer 104 includes components calculated in parts by weight: 95 parts of polyethylene and 4.5 parts of antioxidant agents, 0.5 parts of crosslinking initiator, the third layer 106 includes components calculated in parts by weight: 90 parts of polyethylene, 5 parts of color masterbatch, and 5 parts of ultraviolent agent. It will be appreciated that the percentages and parts of the first, second, and third layers 102, 104, 106 may vary in other examples, not departing from the scope of the present disclosure.

### Definitions

The singular forms “a”, “an” and “the” are intended to include the plural forms as well, unless the context clearly indicates otherwise.

The term “and/or” refers to and encompasses any and all possible combinations of one or more of the associated listed items.

The term “about,” when referring to a measurable value such as an amount of a compound, dose, time, temperature, and the like, is meant to encompass variations of 10%, 5%, 1%, 0.5%, or even 0.1% of the specified amount.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs. In the event of conflicting terminology, the present specification is controlling.

All patents, patent applications and publications referred to herein are incorporated by reference in their entirety.

### Materials

### Polymers

The cross-linkable feedstock for making the polymeric pipes of the disclosure include a polyethylene, such as a high-density polyethylene (HDPE). Polyethylene (PE) is classified into several different categories based mostly on its density and branching. The final product performance and mechanical properties depend significantly on variables such as the extent and type of branching, the crystallinity, the density, and the molecular weight and its distribution. PEX pipes are commonly manufactured from high density polyethylene (HDPE), however, the present disclosure may include a cross-linkable feedstock or a coating composition that may comprise any type of polyolefin or polyethylene is used for the production of single-layer or multi-layer plastic pipes such as, but not limited to, low density polyethylene (LDPE), medium density polyethylene (MDPE), PE 100, PE 80, PE-RT grades, and ultra-high molecular weight polyethylene (UHMWPE) or combinations thereof.

Examples of commercially available HDPE that may be used in pipes of the present disclosure include Borealis HE1878E; Borealis HE1878E-C2; HE1878; Borealis HE2550, each available from Borealis AG, Vienna, Austria; Lupolen 5261Z Q456; Lyondellbasell, Basell Q 456, Basell Q 456B, Basell New Resin, Basell Q 471, (LyondellBasell Company, Clinton Iowa, United States).

### Peroxides

The cross-linkable feedstock of the present disclosure comprises a peroxide. The peroxide may be an organic peroxide. The peroxide may be any appropriate organic peroxide for crosslinking polyolefins. The organic peroxide may be a bi-functional peroxide used for crosslinking of polyolefins.

The organic peroxide may be 2,5-dimethyl-2,5-di(tert-butylperoxy)hexyne-3,for example, available as 85% solution in mineral oil in liquid form commercially available as, for example, Trigonox 145-E85; 3,3,5,7,7-pentamethyl-1,2,4-trioxepane commercially available as Trigonox 311; 2,5-dimethyl-2,5-di(tert-butylperoxy)hexane commercially available as Trigonox 101; each available from Nouryon Functional Chemicals B.V., Radnor, PA. The organic peroxide may be a di-tert-butyl peroxide. The peroxide may be present in the feedstock in from 0.1 to 2 wt %, or 0.5 to 1.0 wt %.

The cross-linkable feedstock compositions according to the disclosure may optionally contain one or more additional additives such as stabilizers, coagents, antioxidants, antimicrobial agents, and pigments.

### Coagents

The cross-linkable feedstock for making the polymeric pipes of the disclosure may optionally comprise a co-agent, for example one or more co-agents. The co-agents (monomers and/or oligomers) that may be used in the formulations in the present disclosure may comprise at least one polymerizable double bond or reactive group. The co-agent may provide additional crosslinks between the polyolefin chains of the polyolefin structural polymer. The co-agent may act to promote and enhance the efficiency of the crosslinking process. The co-agent may be selected from co-agents comprising reactive groups such as acrylates, allyl ethers, polybutadienes, vinyl ethers, and unsaturated vegetable oils, such as soybean oil. For example, the co-agent may be selected from acrylates, allyl ethers, polybutadienes and vinyl ethers. The co-agent may comprise a reactive carbon-carbon double bond. A reactive carbon-carbon double bond may be a carbon-carbon double bond that is a terminal carbon-carbon bond. The co-agent (or total amount of co-agents) may be present in an amount of 0.02 to 10% by weight. For example, the co-agent may be present in an amount of 0.1 to 5% by weight, 0.2 to 1% by weight, 0.3 to 0.7% by weight, e.g., about 0.5% by weight.

### Stabilizers

The cross-linkable feedstock composition according to the disclosure may optionally include a stabilizer. The stabilizer may be a UV stabilizer such as a hindered amine light stabilizer (HALS) or a hindered phenol stabilizer. The cross-linkable feedstock composition includes one or more hindered amine light stabilizers (HALS), e.g., to protect the cured composition from oxidation and degradation. Examples of hindered amine light stabilizers include Tinuvin 123 (Ciba), Tinuvin 622 (Ciba), Tinuvin 770 (Ciba), Cyasorb 3853 (Cytec), Cyasorb 3529 (Cytec) and Hostavin PR-31 (Clariant). A curable composition can include up to about 15% of one or more hindered amine light stabilizers. For example, the composition can include from about 0.1% to about 5%, or from about 0.1% to about 3% of the one or more hindered amine light stabilizers. In other embodiments, the curable composition is substantially free of a light stabilizer.

### Antioxidants

The cross-linkable feedstock composition according to the disclosure may optionally include an antioxidant. The antioxidant may be any appropriate antioxidant. The antioxidant may be a sterically hindered phenolic antioxidant such as Irganox 1010 or Irganox 1076, although alternatives are possible. The antioxidant may be a phosphite or phosphonate antioxidant such as Irgafos 168, although alternatives are possible. The antioxidant may be a preblended package of other antioxidants such as Irganox B225, although alternatives are possible. The antioxidant may be a reactive antioxidant such as reactive hindered phenol 3-(3′,5′-di-tert.-butyl-4′-hydroxy phenyl) propyl-1-acrylate, DBPA; reactive hindered amine 4-acryloyloxyl 1,2,2,6,6-pentamethyl piperdine, AOPP; or reactive hindered amine 4-acryloyloxyl 1,2,2,6,6-tetramethyl piperdine, AOTP, for example, as synthesized in Al-Malaika S, Riasat S, Lewucha C, Reactive antioxidants for peroxide crosslinked polyethylene, Polymer Degradation and Stability (2017), doi: 10.1016/j.polymdegradstab.2017.04.013. The antioxidant may be present in about 0.1% to about 1%, or 0.25% to 0.75%, or about 0.5% by weight in the cross-linkable feedstock composition.

### Uses

The polymeric pipes prepared using the systems and methods of the disclosure comprises cross-linked polyethylene (PEX). The PEX-a pipes may be useful for drinking water pipe, plumbing, heating, and cooling; underfloor heating; wastewater; fire sprinkler systems and the like.

### Pipe Standards and Certifications

The disclosure provides systems and methods for making a PEX pipe that meets or exceeds one or more ASTM, NSF, or ISO standards.

Example pipe standards and standard test procedures referenced in the present disclosure include the following: ASTM International Standard for Crosslinked Polyethylene (PEX) Tubing, ASTM F876-23; ASTM International Standard Specification for Crosslinked Polyethylene (PEX) Plastic Hot-and Cold-Water Distribution Systems, ASTM F877-00 (“ASTM F877”); ASTM International Standard Test Method for Evaluating the Oxidative Resistance of Crosslinked Polyethylene (PEX) Tubing and Systems to Hot Chlorinated Water, F2023-15 (“ASTM F2023”); ASTM International Standard Test Method for Oxidative-Induction Time of Polyolefins by Differential Scanning calorimetry, ASTM D3895-19 (“ASTM D3895”); NSF International Standard/American National Standard for Drinking Water Additives 61-2016 (“NSF 61”); and ISO Standard EN ISO 15875-Plastics piping systems for hot and cold water installations-Crosslinked polyethylene (PE-X). The contents of each of these standards are incorporated herein by reference.

The PEX tubing formed by the systems and methods according to the disclosure is capable of passing ASTM F876 and/or F877 test standards. The wall thickness of PEX tubing is based on Standard Dimension Ratio (SDR) 9. The pipes of the disclosure may be PEX pipes that meet or exceed temperature and pressure ratings requirements of 160 psi at 23° C. (73.4° F.), 100 psi at 82.2° C. (180° F.), and 80 psi at 93.3° C. (200° F.). Minimum burst ratings are 475 psi at 23° C. (73.4° F.) (⅝ inch and larger). PEX pipes of the disclosure may also meet additional performance characteristics and requirements set out in ASTM F876-23, which is incorporated by reference in its entirety.

ASTM F876 is a standard specification for crosslinked polyethylene (PEX) tubing that is outside diameter controlled, made in standard thermoplastic tubing dimension ratios, and pressure rated for water at three temperatures. Included are requirements and test methods for material, workmanship, dimensions, sustained pressure, burst pressure, environmental stress cracking, stabilizer migration resistance, and degree of crosslinking. Methods of marking are also given.

The degree of crosslinking can be quantified in accordance with the following citation from ASTM F876-23: “6.7.Degree of Crosslinking-When tested in accordance with 7.9, the degree of crosslinking for PEX tubing material shall be within the range from 65 to 89% inclusive. Depending on the process used, the following minimum percentage crosslinking values shall be achieved: 70% by peroxides, 65% by electron beam, or 65% by silane compounds”.

The present disclosure provides systems and methods for producing extruded pipes that consistently satisfy a defined target level of crosslinking (XL) of, for example 77%, and may be maintained at that level at approximately 77±4% for a given formulation. In conventional prior art extrusion processes, this variation may be least 3% and up to 5%, or more.

ASTM F877 specification covers requirements, test methods, and methods of making for cross-linked polyethylene plastic hot-and cold-water distribution systems components made in one standard dimension ration and intended for 100 psi (0.69 MPa) water service up to and including a maximum working temperature of 180 F (82° C.). Components are comprised of tubing and fittings. Requirements and test methods are included for materials, workmanship, dimensions and tolerances, hydrostatic sustained pressure strength, thermocycling resistance, fittings, and bend strength.

The systems and methods of the disclosure are able to produce PEX-a pipes that meet or exceed ASTM F877 standards including hot bending minimum radius of 2.5 times the outside diameter (O.D.), cold bending minimum radius of 6 times the outside diameter, and are able to sustain short term conditions of 48 h at 210° F., at 150 psi.

Chlorine resistance may be measured by ASTM F2023 and requires approximately 12-15 months of testing for completion.

A qualitative measure of the level of stabilization may be provided by the oxidative-induction time (OIT) test by differential scanning calorimetry (DSC), as performed in accordance with ASTM D3895.

Specific additives for pipes for drinking water applications may include stabilizers, anti-oxidants, crosslinking agents, processing additives, etc. as part of the cross-linkable feedstock and in the final pipe composition. These additives may be added to provide pipes with desirable physical properties, e.g., pipes that satisfy ASTM F876 and/or EN ISO 15875 requirements. These chemical additives may be, however, typically subject to leaching from the final chemical pipe. Leaching of chemicals out of the pipe is, however, undesirable. In addition, for certain applications there are limits set on levels of leached chemicals. For example, NSF 61 sets limits on chemical leaching for drinking water pipes. Drinking water pipes in North America must pass the NSF 61 test. The purpose of this test is to assure the customer that the quality of the water inside the pipe is not compromised by chemicals leaching into it. There are three ways to complete this test: 1) single point test, 2) 21-Day multipoint test and 3) 107-Day multipoint test. All three tests involve changing the water inside the pipe every 24 hours over an extended period of time. For the single point test only the water extract on Day 17 is tested. For the multipoint tests the water extracts on several days are analyzed and the resulting data is then used to create a decay curve. The water extracts may be analyzed by a Gas Chromatograph equipped with a Mass Spectrometer (GC/MS). If deemed necessary, other analytical techniques are also used. Twenty-four hours prior to collecting a sample for analysis, some of the samples are exposed at an elevated temperature, either 60° C. or 82° C., for 30 minutes. The heated extracts are then analyzed by GC/MS for semi-volatile compounds using EPA624 method. The rest of the samples are conditioned at room temperature and then analyzed by GC/MS for volatile compounds using EPA524 method.

To pass the multipoint tests the concentration of all chemicals extracted into the water must decay to below the Short Term Exposure Limit (STEL) on Day 17 and Total Allowable Concentration (TAC) on Day 107. For the single point test both the STEL and TAC limits must be met on Day 17. The allowance limits of NSF 61 were typically in the in the ppm range until recent years when the requirements have become more stringent, for example with the limits set in the ppb range for a number of compounds in current NSF standards.

The term “STEL” refers to the short term exposure limit. It typically represents the maximum concentration of a contaminant (e.g. a compound) that is permitted by a standard. For example, the NSF 61 standard specifies STEL values that represent the maximum concentration of a contaminant that is permitted in drinking water for an acute exposure calculated in accordance with the standard.

The term “TAC” refers to total allowable concentration. This is typically the maximum concentration of a contaminant (e.g. a compound) that a single product is allowed to contribute to a fluid. For example, the NSF 61 standard specifies TAC values that represent the maximum concentration of a contaminant in drinking water that a single product is allowed to contribute in accordance with the standard.

The principles, techniques, and features described herein can be applied in a variety of systems, and there is no requirement that all of the advantageous features identified be incorporated in an assembly, system or component to obtain some benefit according to the present disclosure.

From the forgoing detailed description, it will be evident that modifications and variations can be made without departing from the spirit and scope of the disclosure.

What is claimed is:

1. A method of making an elongated tubular element, comprising:
simultaneously extruding a first layer of resin, a second layer of resin, and a third layer of resin through a die head to form the elongated tubular element having a circular cross-section, wherein the first and third layers of resin comprise non-cross-linkable material and the second layer of resin comprises a cross-linkable material; and
exposing the elongated tubular element to infrared lamps to cross link the second layer of resin of the elongated tubular element.

2. The method according to claim 1, further comprising cooling the elongated tubular element in a cooling bath.

3. The method according to claim 1, wherein the level of cross-linking of the second layer of the elongated tubular element is within a range of 70% to 89%, 70% to 80%, or at least 70% when tested according to ASTM F876.

4. The method according to claim 1, wherein the elongated tubular element meets or exceeds chlorine resistance standard according to ASTM F876.

5. The method according to claim 1, wherein the outer diameter (O.D.) of the elongated tubular element is within +/−0.3 mm, within +/−0.2 mm, or within +/−0.1 mm when measured at a plurality of intervals along the elongated tubular.

6. The method according to claim 1, wherein the second layer of resin of the elongated tubular element is a PEX-a pipe, a PEX-b pipe, or PEX-c pipe.

7. The method according to claim 1, wherein the cross-linkable material comprises high-density polyethylene (HPDE) and an organic peroxide; optionally further comprising one or more additives selected from the group consisting of a stabilizer, plasticizer, and antioxidant.

8. An elongated tubular element, comprising:
a first layer of resin having a non-cross-linkable material;
a second layer of resin having a cross-linkable material, and
a third layer of resin having a non-cross-linkable material;
wherein the mass percent of the first and third layers is less than 10%; and
wherein the first, second, and third layers are simultaneously co-extruded through a die head to form the elongated tubular element having a circular cross-section.

9. The elongated tubular element according to claim 8, wherein the level of cross-linking of the second layer of the elongated tubular element is within a range of 70% to 89%, 70% to 80%, or at least 70% when tested according to ASTM F876.

10. The elongated tubular element according to claim 8, wherein the elongated tubular element meets or exceeds chlorine resistance standard according to ASTM F876.

11. The elongated tubular element according to claim 8, wherein the outer diameter (O.D.) of the elongated tubular element is within +/−0.3 mm, within +/−0.2 mm, or within +/−0.1 mm when measured at a plurality of intervals along the elongated tubular.

12. The elongated tubular element according to claim 8, wherein the second layer of resin of the elongated tubular element is a PEX-a pipe, a PEX-b pipe, or PEX-c pipe.

13. The elongated tubular element according to claim 8, wherein the cross-linkable material comprises high-density polyethylene (HPDE) and an organic peroxide; optionally further comprising one or more additives selected from the group consisting of a stabilizer, plasticizer, and antioxidant.

14. A three-layer co-extruded pipe, comprising:
an elongated tube wall having three layers simultaneously co-extruded together, the three layers from outside within be respectively a color layer, a main PEX layer, and a protective layer.

15. The three-layer co-extruded pipe according to claim 14, wherein the thickness ratio of the color layer. the main PEX layer, and the protective layer ranges between 1:25:1 to 1:88:1.
